(19) United States
(12) Patent Application Publication
(10) Pub. No.: US 2024/0134913 A1
(43) Pub. Date: Apr. 25, 2024

(54) KEYED ROW SELECTION

(71) Applicant: Deephaven Data Labs LLC, Plymouth, MN (US)

(72) Inventors: Charles Wright, Cortlandt Manor, NY (US); Ryan Caudy, New York, NY (US); David R. Kent, IV, Colorado Springs, CO (US); Andrew Louis Baranec, Deer Park, NY (US); Mark Zeldis, Randolph, NJ (US); Radu Teodorescu, New York, NY (US)

(73) Assignee: Deephaven Data Labs LLC, Plymouth, MN (US)

(21) Appl. No.: 18/402,704

(22) Filed: Jan. 2, 2024

Related U.S. Application Data
(63) Continuation of application No. 17/038,388, filed on Sep. 30, 2020, now Pat. No. 11,860,948.
Application No. 17/038,388 is a continuation of application No. 15/813,119, filed on Nov. 14, 2017, now Pat. No. 10,866,943.
(60) Provisional application No. 62/549,908, filed on Aug. 24, 2017.

(51) Int. Cl. G06F 16/903; G06F 3/0481; G06F 16/11; G06F 16/21; G06F 16/22; G06F 16/23; G06F 16/27; G06F 16/28; G06F 16/532; G06F 16/901; G06F 16/9038; G06F 16/904; G06T 11/20

(52) U.S. Cl. CPC G06F 16/90335; G06F 3/0481; G06F 16/128; G06F 16/21; G06F 16/221; G06F 16/23; G06F 16/235; G06F 16/2358; G06F 16/2365; G06F 16/2372; G06F 16/27; G06F 16/289; G06F 16/532; G06F 16/901; G06F 16/9024; G06F 16/9038; G06F 16/904; G06T 11/206; G06F 16/489

(57) ABSTRACT

Described are methods, systems and computer readable media for keyed row data selection and processing.

This application is a continuation of U.S. application Ser. No. 15/813,119, entitled “Keyed Row Selection” and filed on Nov. 14, 2017, which claims the benefit of U.S. Provisional Application No. 62/549,908, entitled “COMPUTER DATA SYSTEM” (Attorney Docket No. W0.2-10177) and filed on Aug. 24, 2017, which is incorporated herein by reference in its entirety.

Embodiments relate generally to computer data systems, and more particularly, to methods, systems and computer readable media for keyed row data selection and processing.

Some graphical user interfaces may provide a display of information from a database query result or other computer data system data object or source. Data selected on a graphical user interface may occur within a dynamically updating display of data (e.g., a query result) that is changing over time. A need may exist to provide for a selection of data to persist within a dynamically updating data object or data source, even when such selection is no longer visible within the graphical user interface.

Some implementations were conceived in light of the above mentioned needs, problems and/or limitations, among other things.

Some implementations can include a computer-implemented method for processing keyed row selection of a computer data system data object. The method can include receiving, at a processor, a selection of one or more keyed rows of the computer data system data object, the selection being received from a graphical user interface that is displaying at least a portion of data from the computer data system object, and adding, using the processor, one or more key values corresponding to the selection to a selected key values set stored in a computer readable medium coupled to the processor. The method can also include receiving, at the processor, an indication of an operation that utilizes data corresponding to the one or more key values, and determining, at the processor, whether the data corresponding to the one or more key values is stored within a local data store. The method can further include, when the data corresponding to the one or more key values is stored within the local data store: retrieving, using the processor, the data corresponding to the one or more key values from the local data store, and providing, using the processor, data retrieved from the local data store to an application.

The method can also include determining, at the processor, whether a portion of the data corresponding to the one or more key values is not stored in the local data store and is stored in a remote data store, and when a portion of the data corresponding to the one or more key values is not stored in the local data store and is stored in the remote data store: requesting, using the processor, data from the remote data store, and receiving, at the processor, at least a portion of requested data from the remote data store. The method can further include providing, using the processor, data received from the remote data store to the application.

The method can also include updating the graphical user interface based on the selection. The method can further include maintaining the selected key values set when the selection is no longer visible within the graphical user interface.

Providing data received from the local data store to the application and providing data received from the remote data store to the application can include storing received data in a temporary working data store. The method can also include receiving an update to the computer data system data object, wherein the update includes a change to the selection, and performing an update on the selection based on the update to the computer data system data object.

Data returned from the remote data store can include indexes for accessing data stored on remote data store. The method can further include receiving, at the processor, an indication that a new row has been added to the computer data system data object, and determining, using the processor, whether the new row is within the selection based on the selected key values set. The method can also include, if the new row is part of the selection: updating, using the processor, the graphical user interface to indicate the new row is within the selection, and providing, from the processor, the new row to the application. The method can further include resetting the selected key values set when a new selection is received.

Some implementations can include a system for dynamically updating a remote computer data system data object. The system can include a processor coupled to a nontransitory computer readable medium having stored thereon software instructions that, when executed by the processor, cause the processor to perform operations. The operations can include receiving, at a processor, a selection of one or more keyed rows of the computer data system data object, the selection being received from a graphical user interface that is displaying at least a portion of data from the computer data system object. The operations can also include adding, using the processor, one or more key values corresponding to the selection to a selected key values set stored in a computer readable medium coupled to the processor, and receiving, at the processor, an indication of an operation that utilizes data corresponding to the one or more key values. The operations can further include determining, at the processor, whether the data corresponding to the one or more key values is stored within a local data store.

The operations can also include, when the data corresponding to the one or more key values is stored within the local data store: retrieving, using the processor, the data corresponding to the one or more key values from the local data store, and providing, using the processor, data retrieved from the local data store to an application. The operations can further include determining, at the processor, whether a portion of the data corresponding to the one or more key values is not stored in the local data store and is stored in a remote data store.

The operations can also include, when a portion of the data corresponding to the one or more key values is not stored in the local data store and is stored in the remote data store: requesting, using the processor, data from the remote data store, and receiving, at the processor, at least a portion of requested data from the remote data store. The operations can further include providing, using the processor, data received from the remote data store to the application.

The operations can also include updating the graphical user interface based on the selection. The operations can further include maintaining the selected key values set when the selection is no longer visible within the graphical user interface. Providing data received from the local data store to the application and providing data received from the remote data store to the application can include storing received data in a temporary working data store.

The operations can also include receiving an update to the computer data system data object, wherein the update includes a change to the selection, and performing an update on the selection based on the update to the computer data system data object. The data returned from the remote data store can include indexes for accessing data stored on remote data store.

The operations can also include receiving, at the processor, an indication that a new row has been added to the computer data system data object, and determining, using the processor, whether the new row is within the selection based on the selected key values set. The operations can further include, if the new row is part of the selection: updating, using the processor, the graphical user interface to indicate the new row is within the selection, and providing, from the processor, the new row to the application. The operations can also include resetting the selected key values set when a new selection is received.

Some implementations can include a nontransitory computer readable medium having stored thereon software instructions that, when executed by a processor, cause the processor to perform operations. The operations can include receiving, at a processor, a selection of one or more keyed rows of the computer data system data object, the selection being received from a graphical user interface that is displaying at least a portion of data from the computer data system object, and adding, using the processor, one or more key values corresponding to the selection to a selected key values set stored in a computer readable medium coupled to the processor. The operations can also include receiving, at the processor, an indication of an operation that utilizes data corresponding to the one or more key values, and determining, at the processor, whether the data corresponding to the one or more key values is stored within a local data store. The operations can further include when the data corresponding to the one or more key values is stored within the local data store: retrieving, using the processor, the data corresponding to the one or more key values from the local data store, and providing, using the processor, data retrieved from the local data store to an application. The operations can also include determining, at the processor, whether a portion of the data corresponding to the one or more key values is not stored in the local data store and is stored in a remote data store.

The operations can further include, when a portion of the data corresponding to the one or more key values is not stored in the local data store and is stored in the remote data store: requesting, using the processor, data from the remote data store, and receiving, at the processor, at least a portion of requested data from the remote data store. The operations can also include providing, using the processor, data received from the remote data store to the application.

The operations further can include updating the graphical user interface based on the selection. The operations can further include maintaining the selected key values set when the selection is no longer visible within the graphical user interface. Providing data received from the local data store to the application and providing data received from the remote data store to the application can include storing received data in a temporary working data store.

### BRIEF DESCRIPTION OF THE DRAWINGS

FIG. 1 is a diagram of an example computer data system showing an example data distribution configuration in accordance with some implementations.

FIG. 2 is a diagram of an example computer data system showing an example administration/process control arrangement in accordance with some implementations.

FIG. 3 is a diagram of an example computing device configured for GUI control element processing in accordance with some implementations.

FIG. 4 is a flowchart of an example method for keyed row data selection and processing in accordance with some implementations.

FIG. 5 is a diagram of an example graphical user interface of a computer data system in accordance with some implementations.

FIG. 6 is a diagram of an example graphical user interface showing a selection of a row of a data object in accordance with some implementations.

FIG. 7 is a diagram of an example graphical user interface showing a selection of a row of a data object in accordance with some implementations.

FIG. 8 is a diagram of an example graphical user interface showing selection expansion for a key value of a data object in accordance with some implementations.

FIG. 9 is a diagram of an example graphical user interface of a computer data system in which the selected rows are no longer visible in accordance with some implementations.

FIG. 10 is a diagram showing an example selected data portion existing in a local data store and a remote data store in accordance with some implementations.

### DETAILED DESCRIPTION

Reference may be made herein to the Java programming language, Java classes, Java bytecode and the Java Virtual Machine (JVM) for purposes of illustrating example implementations. It will be appreciated that implementations can include other programming languages (e.g., groovy, Scala, R, Go, etc.), other programming language structures as an alternative to or in addition to Java classes (e.g., other language classes, objects, data structures, program units, code portions, script portions, etc.), other types of bytecode, object code and/or executable code, and/or other virtual machines or hardware implemented machines configured to execute a data system query.

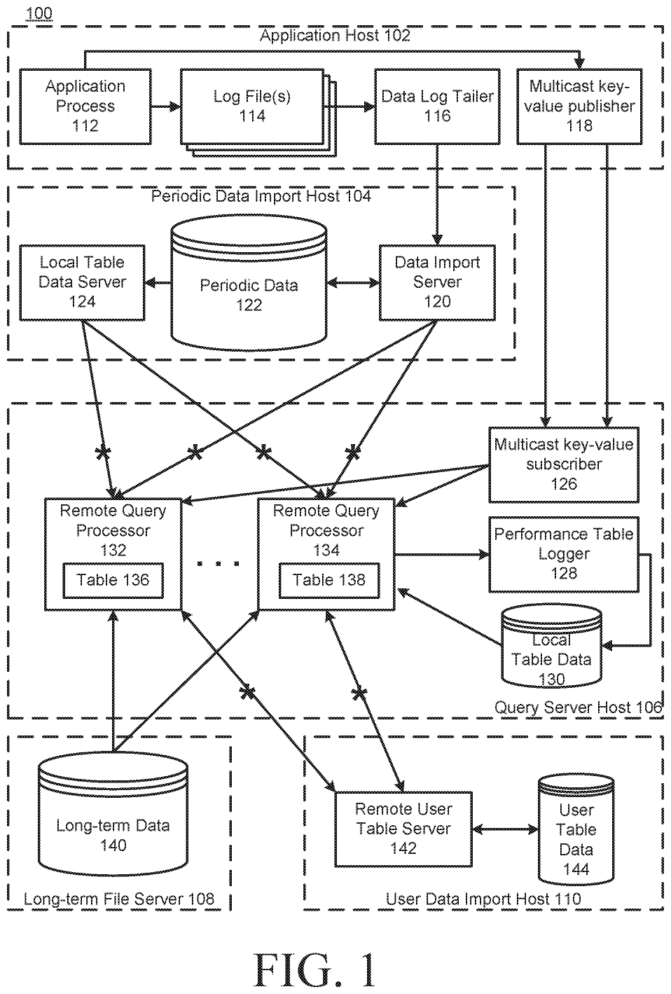

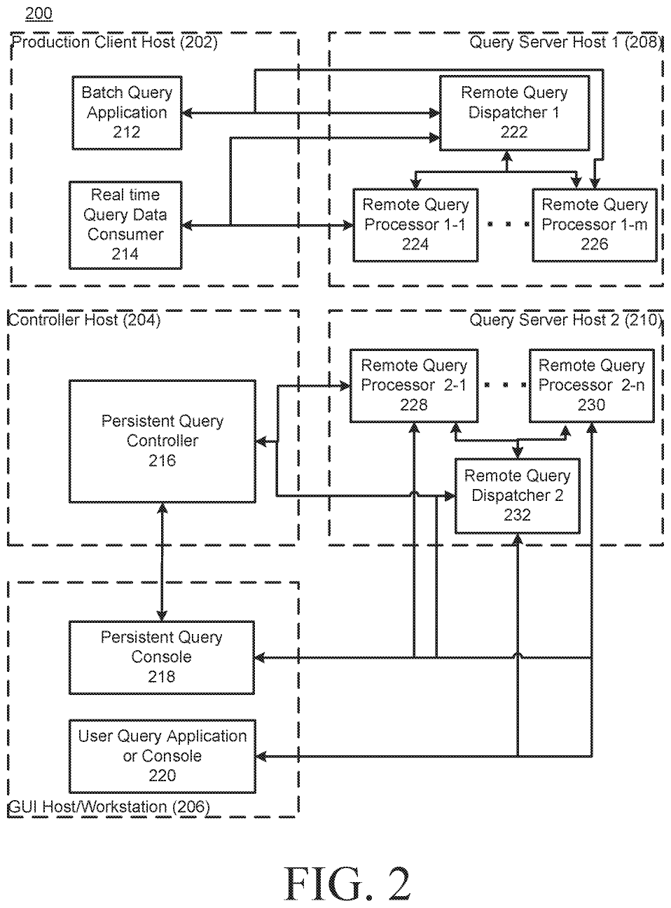

FIG. 1 is a diagram of an example computer data system and network 100 showing an example data distribution configuration in accordance with some implementations. In particular, the system 100 includes an application host 102, a periodic data import host 104, a query server host 106, a long-term file server 108, and a user data import host 110. While tables are used as an example data object in the description below, it will be appreciated that the data system described herein can also process other data objects such as mathematical objects (e.g., a singular value decomposition of values in a given range of one or more rows and columns of a table), TableMap objects, etc. A TableMap object provides the ability to lookup a Table by some key. This key represents a unique value (or unique tuple of values) from the columns aggregated on in a byExternal( ) statement execution, for example. A TableMap object can be the result of a byExternal( ) statement executed as part of a query. It will also be appreciated that the configurations shown in FIGS. 1 and 2 are for illustration purposes and in a given implementation each data pool (or data store) may be directly attached or may be managed by a file server.

The application host 102 can include one or more application processes 112, one or more log files 114 (e.g., sequential, row-oriented log files), one or more data log tailers 116 and a multicast key-value publisher 118. The periodic data import host 104 can include a local table data server, direct or remote connection to a periodic table data store 122 (e.g., a column-oriented table data store) and a data import server 120. The query server host 106 can include a multicast key-value subscriber 126, a performance table logger 128, local table data store 130 and one or more remote query processors (132, 134) each accessing one or more respective tables (136, 138). The long-term file server 108 can include a long-term data store 140. The user data import host 110 can include a remote user table server 142 and a user table data store 144. Row-oriented log files and column-oriented table data stores are discussed herein for illustration purposes and are not intended to be limiting. It will be appreciated that log files and/or data stores may be configured in other ways. In general, any data stores discussed herein could be configured in a manner suitable for a contemplated implementation.

In operation, the input data application process 112 can be configured to receive input data from a source (e.g., a securities trading data source), apply schema-specified, generated code to format the logged data as it's being prepared for output to the log file 114 and store the received data in the sequential, row-oriented log file 114 via an optional data logging process. In some implementations, the data logging process can include a daemon, or background process task, that is configured to log raw input data received from the application process 112 to the sequential, row-oriented log files on disk and/or a shared memory queue (e.g., for sending data to the multicast publisher 118). Logging raw input data to log files can additionally serve to provide a backup copy of data that can be used in the event that downstream processing of the input data is halted or interrupted or otherwise becomes unreliable.

A data log tailer 116 can be configured to access the sequential, row-oriented log file(s) 114 to retrieve input data logged by the data logging process. In some implementations, the data log tailer 116 can be configured to perform strict byte reading and transmission (e.g., to the data import server 120). The data import server 120 can be configured to store the input data into one or more corresponding data stores such as the periodic table data store 122 in a column-oriented configuration. The periodic table data store 122 can be used to store data that is being received within a time period (e.g., a minute, an hour, a day, etc.) and which may be later processed and stored in a data store of the long-term file server 108. For example, the periodic table data store 122 can include a plurality of data servers configured to store periodic securities trading data according to one or more characteristics of the data (e.g., a data value such as security symbol, the data source such as a given trading exchange, etc.).

The data import server 120 can be configured to receive and store data into the periodic table data store 122 in such a way as to provide a consistent data presentation to other parts of the system. Providing/ensuring consistent data in this context can include, for example, recording logged data to a disk or memory, ensuring rows presented externally are available for consistent reading (e.g., to help ensure that if the system has part of a record, the system has all of the record without any errors), and preserving the order of records from a given data source. If data is presented to clients, such as a remote query processor (132, 134), then the data may be persisted in some fashion (e.g., written to disk).

The local table data server 124 can be configured to retrieve data stored in the periodic table data store 122 and provide the retrieved data to one or more remote query processors (132, 134) via an optional proxy.

The remote user table server (RUTS) 142 can include a centralized consistent data writer, as well as a data server that provides processors with consistent access to the data that it is responsible for managing. For example, users can provide input to the system by writing table data that is then consumed by query processors.

The remote query processors (132, 134) can use data from the data import server 120, local table data server 124 and/or from the long-term file server 108 to perform queries. The remote query processors (132, 134) can also receive data from the multicast key-value subscriber 126, which receives data from the multicast key-value publisher 118 in the application host 102. The performance table logger 128 can log performance information about each remote query processor and its respective queries into a local table data store 130. Further, the remote query processors can also read data from the RUTS, from local table data written by the performance logger, or from user table data read over NFS, for example.

It will be appreciated that the configuration shown in FIG. 1 is a typical example configuration that may be somewhat idealized for illustration purposes. An actual configuration may include one or more of each server and/or host type. The hosts/servers shown in FIG. 1 (e.g., 102-110, 120, 124 and 142) may each be separate or two or more servers may be combined into one or more combined server systems. Data stores can include local/remote, shared/isolated and/or redundant. Any table data may flow through optional proxies indicated by an asterisk on certain connections to the remote query processors. Also, it will be appreciated that the term “periodic” is being used for illustration purposes and can include, but is not limited to, data that has been received within a given time period (e.g., millisecond, second, minute, hour, day, week, month, year, etc.) and which has not yet been stored to a long-term data store (e.g., 140).

FIG. 2 is a diagram of an example computer data system 200 showing an example administration/process control arrangement in accordance with some implementations. The system 200 includes a production client host 202, a controller host 204, a GUI host or workstation 206, and query server hosts 208 and 210. It will be appreciated that there may be one or more of each of 202-210 in a given implementation.

The production client host 202 can include a batch query application 212 (e.g., a query that is executed from a command line interface or the like) and a real time query data consumer process 214 (e.g., an application that connects to and listens to tables created from the execution of a separate query). The batch query application 212 and the real time query data consumer 214 can connect to a remote query dispatcher 222 and one or more remote query processors (224, 226) within the query server host 1 208.

The controller host 204 can include a persistent query controller 216 configured to connect to a remote query dispatcher 232 and one or more remote query processors 228-230. In some implementations, the persistent query controller 216 can serve as the “primary client” for persistent queries and can request remote query processors from dispatchers, and send instructions to start persistent queries. For example, a user can submit a query to 216, and 216 starts and runs the query every day. In another example, a securities trading strategy could be a persistent query. The persistent query controller can start the trading strategy query every morning before the market opened, for instance. It will be appreciated that 216 can work on times other than days. In some implementations, the controller may require its own clients to request that queries be started, stopped, etc. This can be done manually, or by scheduled (e.g., cron) jobs. Some implementations can include “advanced scheduling” (e.g., auto-start/stop/restart, time-based repeat, etc.) within the controller.

The GUI/host workstation can include a user console 218 and a user query application 220. The user console 218 can be configured to connect to the persistent query controller 216. The user query application 220 can be configured to connect to one or more remote query dispatchers (e.g., 232) and one or more remote query processors (228, 230).

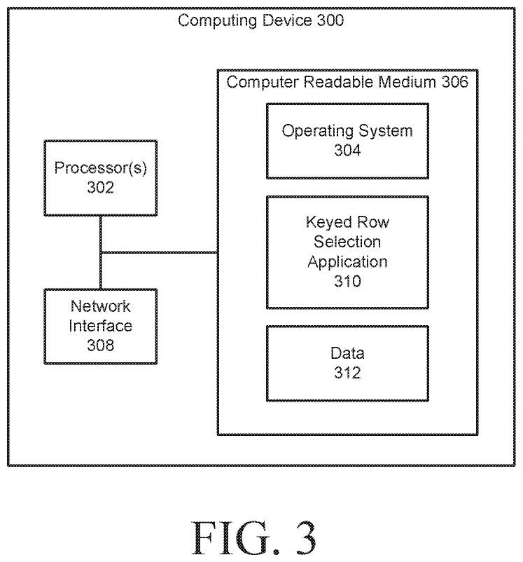

FIG. 3 is a diagram of an example computing device 300 in accordance with at least one implementation. The computing device 300 includes one or more processors 302, operating system 304, computer readable medium 306 and network interface 308. The memory 306 can include a keyed row selection application 310 and a data section 312 (e.g., for storing in-memory tables, etc.).

In operation, the processor 302 may execute the application 310 stored in the memory 306. The application 310 can include software instructions that, when executed by the processor, cause the processor to perform operations for dynamic updating of query result displays in accordance with the present disclosure (e.g., performing one or more of 402-420 described below).

The application program 310 can operate in conjunction with the data section 312 and the operating system 304.

As used herein, a data source can include, but is not limited to, a real time or near real time data source such as securities market data (e.g., over a multicast distribution mechanism (e.g., 118/126) or through a tailer (e.g., 116), system generated data, historical data, user input data from a remote user table server, tables programmatically generated in-memory, or an element upstream in an update propagation graph (UPG) such as a directed acyclic graph (DAG), and/or any data (e.g., a table, mathematical object, etc.) having a capability to refresh itself/provide updated data.

When a data source is updated, it will send add, delete, modify, reindex (AMDR) notifications through the DAG. It will be appreciated that a DAG is used herein for illustration purposes of a possible implementation of the UPG, and that the UPG can include other implementations. A reindex message is a message to change the indexing of a data item, but not change the value. When a table is exported from the server to a client, there is an exported table handle created and that handle attaches itself to the DAG; as a child of the table to be displayed. When the DAG updates, that handle's node in the DAG is reached and a notification is sent across the network to the client that includes the rows which have been added/modified/deleted/reindexed. On the client side, those rows are reconstructed and an in-memory copy of the table (or portion thereof) is maintained for display (or other access).

There can be two cases in which a view is updated. In the first case, a system clock ticks, and there is new data for one or more source (parent) nodes in the DAG, which percolates down to the exported table handle. In the second case, a user changes the “viewport”, which is the active set of rows and columns.

There can be various ways the viewport is caused to be updated, such as: (i) scrolling the view of the table, (ii) showing or hiding a table, (iii) when the user or client program programmatically accesses the table, and/or (iv) adding/removing columns from a view. When the viewport is updated, the viewport is automatically adjusted to include the rows/columns that the user is trying to access with exponential expansion up to a limit for efficiency. After a timeout, any automatically created viewports are closed.

A query result may not change without a clock tick that has one or more AMDR messages which traverse the DAG. However, the portion of a query result that is displayed by the user (e.g., the viewport) might change. When a user displays a table, a set of visible columns and rows is computed. In addition to the visible set of rows/columns, the system may compute (and make available for possible display) more data than is visible. For example, the system may compute and make available for possible display three screens of data: the currently visible screen and one screen before and one screen after. If there are multiple views of the same table, either multiple exported table handles are created in which case the views are independent or if a single exported table handle is created, the viewport is the union of the visible sets. As the user scrolls the table, the viewport may change. When the viewport changes, the visible area (with a buffer of rows up and down, and columns left and right, so that scrolling is smooth) is computed and the updated visible area is sent to the server. In response, the server sends a snapshot with relevant portions of those newly visible rows/columns. For non-displayed tables, the visible area can be considered the whole table by the system for further processing so that a consistent table view is available for further processing (e.g., all rows and one or more columns of the data object may be sent to the client).

The snapshot can be generated asynchronously from the DAG update/table refresh loop under the condition that a consistent snapshot (i.e., the clock value remains the same throughout the snapshot) is able to be obtained. If a consistent snapshot is not obtained after a given number of attempts (e.g., three attempts), a lock can be obtained (e.g., the LiveTableMonitor lock) at the end of the current DAG update cycle to lock out updates while the snapshot is created.

Further, the remote query processor (or server) has knowledge of the visible regions and will send data updates for the visible rows/columns (e.g., it can send the entire AMDR message information so the client has information about what has been updated, just not what the actual data is outside of its viewport). This enables the client optionally to cache data even if the data is outside the viewport and only invalidate the data once the data actually changes.

The DAG structure can be maintained in the memory of a remote query processor. Child nodes have hard references back to their parents, and parents have weak references to their children. This ensures that if a child exists, its parent will also exist, but if there are no external references to a child, then a garbage collection event can properly clean the child up (and the parent won't hold onto the child). For the exported table handles, a component (e.g., an ExportedTableHandleManager component) can be configured to hold hard references to the exported tables. If a client disconnects, then the references for its tables can be cleaned up. Clients can also proactively release references.

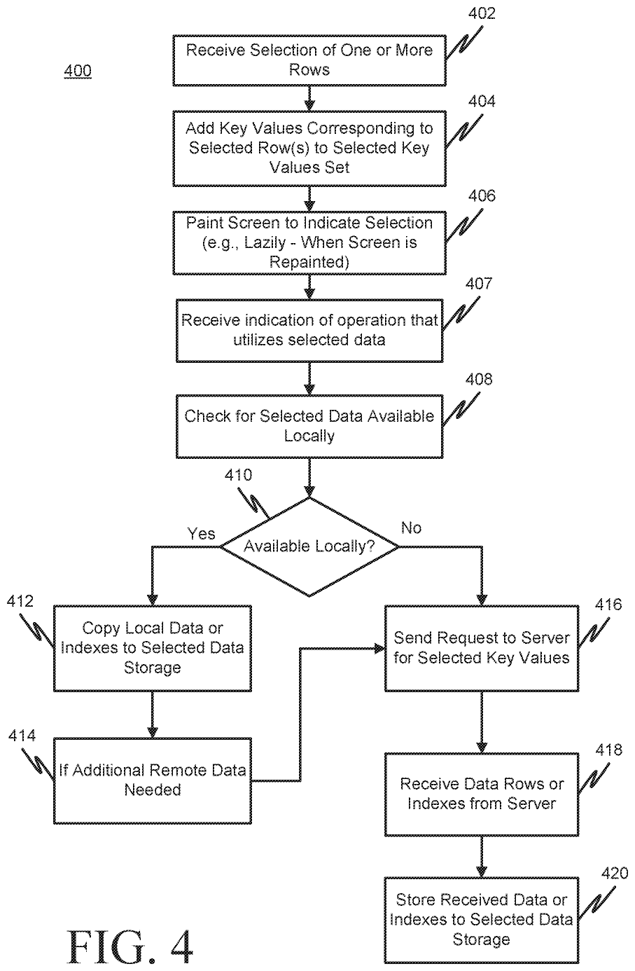

FIG. 4 is a flowchart of an example method 400 for keyed row data selection and processing in accordance with some implementations. Processing begins at 402, where a selection of one or more rows within a computer data system data object or data source is received. The selection can be received from a graphical user interface (GUI) displaying a portion of the data object or data source and can be based on one or more rows selected by a user in the GUI (e.g., via mouse click and/or drag of a row or a field within a row, combination of keyboard command and mouse action, touch screen input, voice input, keyboard input, etc.). A user can select multiple rows using input commands such as mouse input in combination with keyboard input (e.g., mouse clicking while pressing a CTRL or Shift key on a key board, etc.).

The selected row(s) can include a key field. The key can be unique or non-unique. For example, if the data object is keyed on a given field, the selection of a row can cause the system to automatically select the other rows in the data object having a key field that matches the key field value of the one or more rows that were selected by the user. Matching can include an exact match of a key field value or matching when a key field value is within a given threshold number of a key field value of a selected row. Processing continues to 404.

At 404, one or more key values corresponding to the one or more selected are added to a selected key values set. For example, a key value is read from a row that was selected by a user and the key value from the selected row (or rows) is added to the selected key values set. Processing continues to 406.

At 406, the GUI is refreshed (or repainted) to show the selected row(s). The repainting of the GUI to reflect the selection can be performed “lazily”, according to the GUI refresh rate, or when processing permits. Processing continues to 407.

At 407, an indication of an operation that utilizes data from rows corresponding to the selected key values set is received. For example, an indication of a copy operation can be received (e.g., when a user performs a copy operation via keystroke such as control-C or via mouse operation or menu selection). The copy operation references the selected row(s). Other operations could utilize the selected rows. Processing continues to 408.

At 408, once the indication of an operation that utilizes the selected row(s), the system can determine whether the data is present in a local data store (e.g., within the local memory of a client device or system). Programmatically determining whether data from the selected row(s) is present locally can be accomplished by comparing indexes of rows corresponding to the selected key value set to the indexes of rows stored in the local data store. It will be appreciated that the there can be at least three ranges of rows (or other data aspects) associated with a data object: a range of data visible within the GUI, a range of data stored in a local data store and a range of data stored in a remote data store. Processing continues to 410.

At 410, it is determined whether data corresponding to the selected row(s) is available locally. If the data, or a portion of the data, is available locally, processing continues to 412. If there is no locally available data corresponding to the selection, processing continues to 416. In some implementations, the system may choose to ignore local data if there is a possibility that some data may not be local. By ignoring local data, the system can help ensure that a consistent snapshot of data is created on the remote data store rather than producing potentially inconsistent results (e.g., with some data from a local store and some from a remote store) in the face of concurrent update operations.

At 412, the local data and/or indexes to the local data are copied to a local temporary working data store (e.g., clipboard memory, scratchpad storage, etc.). Processing continues to 414.

At 414, if the system determines that additional data is needed beyond the data locally available (e.g., when a portion of the data corresponding to the selected row(s) is available from the local data store and a portion is not available in the local data store), processing continues to 416.

At 416, a requesting system (e.g., a remote query processor, a client system, etc.) sends a request to a remote data server (e.g., 104 or 108) for data from a remote data store corresponding to the selected key value set. For example, the system could send a request for data from a remote data store in which a given key field has a value matching one of the values in the selected key value set. Processing continues to 418.

At 418, the requesting system receives data rows or indexes to the requested data in the remote data store. The remote data server may provide a copy of the data if the size of the data being provided is less than a threshold size. If the size of the data being provided is greater than the threshold data size, then the remote data server may provide a set of indexes into one or more remote data objects so that the requesting system can retrieve the data as memory space, time, etc. permit. By providing the indexes of the remote data, the system can improve the performance of a distributed computer data system in which a client system may not have sufficient memory, processing, network or other resources to accommodate the amount of data represented by the selection or the selected key value set. Processing continues to 420.

At 420, the data and/or indexes corresponding to the selected key value set is stored in a selected data storage such as a temporary working memory area (e.g., clipboard, memory scratchpad, etc.) for subsequent use. For example, a user may select one or more rows, then provide a copy command (e.g., via control-C or the like). In response, the system may copy the selected data into the clipboard of the user's system (e.g., a client system).

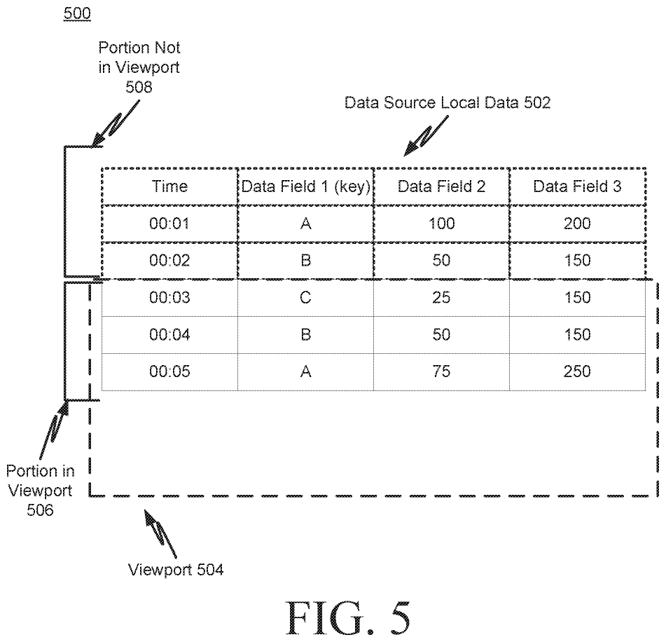

FIG. 5 is a diagram of an example graphical user interface 500 (GUI) of a computer data system in accordance with some implementations. The GUI 500 includes data source local data 502, a GUI viewport 504, a portion of data visible within the GUI viewport 506, and a portion of data not visible within the GUI viewport 508.

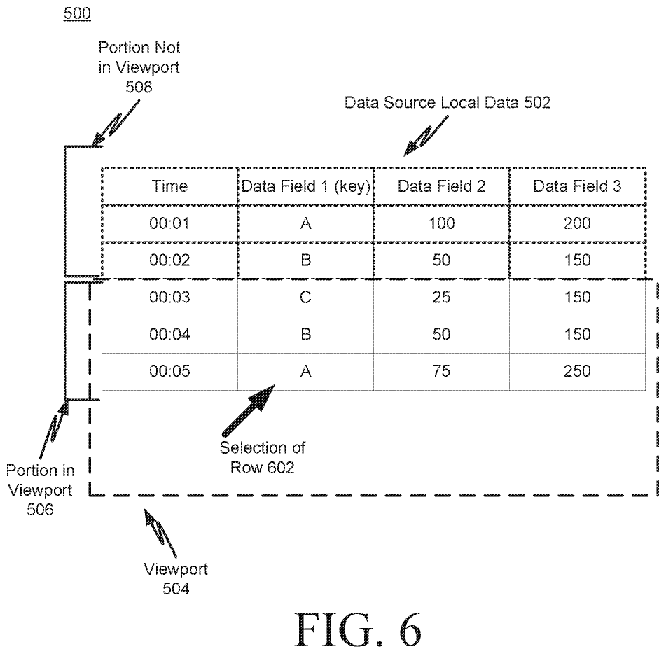

FIG. 6 is a diagram of GUI 500 showing a selection of a row of a data object 602. The selected row has a key value of A as shown in the data field 1 column, which is the key field in this example, which is simple for illustration purposes. A key need not be limited to a single value. In some implementations, a key can include a composite of several values to more specifically define rows.

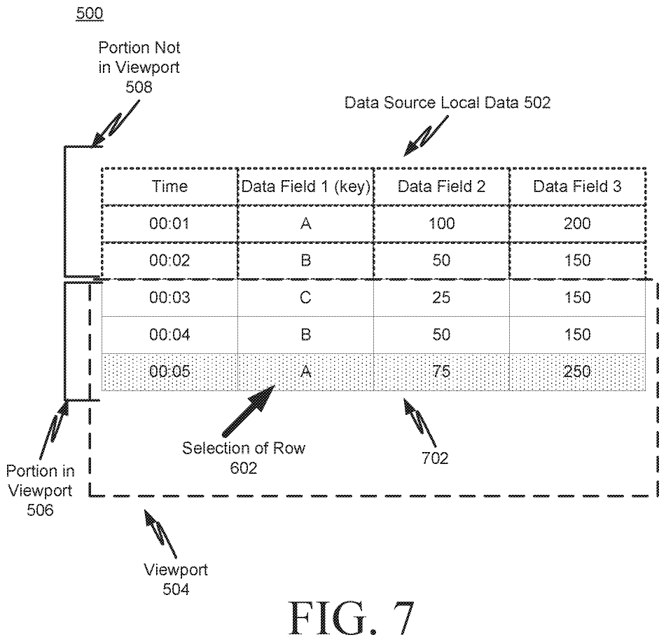

FIG. 7 is a diagram of GUI 500 a selection of a row 702 of the data object. As shown in FIG. 7, the row has been displayed as selected (e.g., has different background formatting or other display attributes from the unselected rows within the viewport).

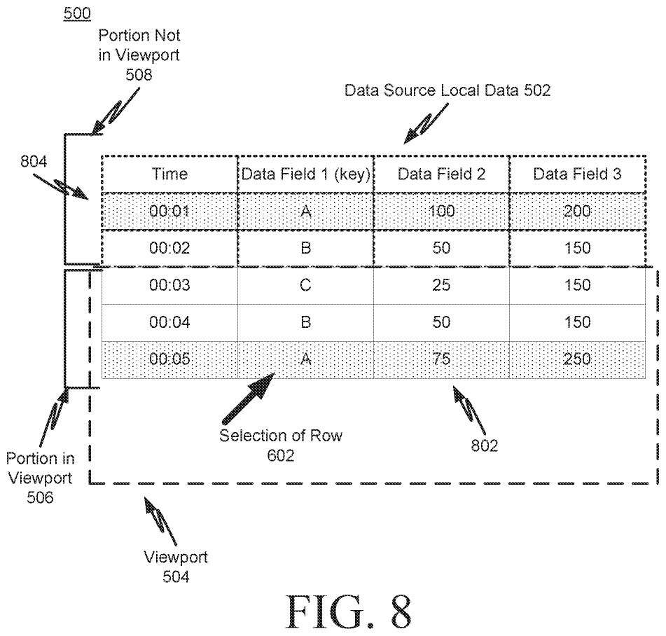

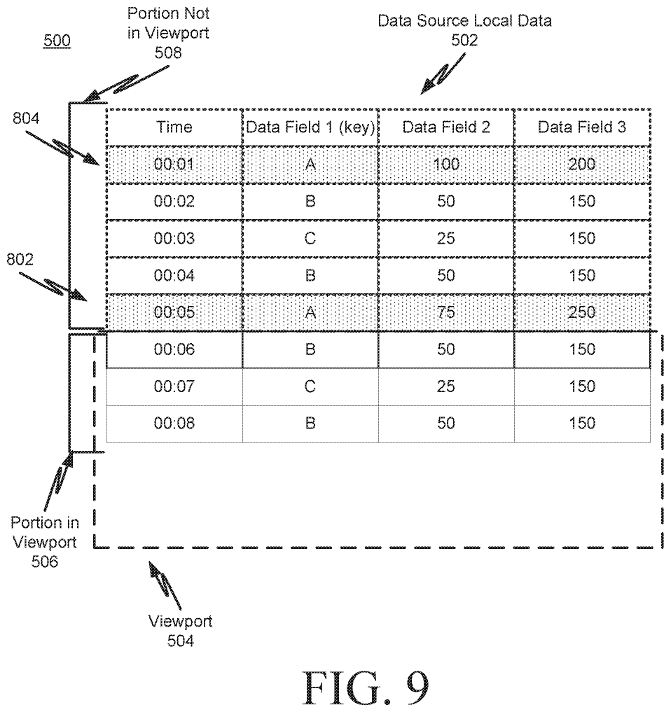

FIG. 8 is a diagram of the GUI 500 showing selection expansion for a key value of a data object. In particular, the selection has been automatically expanded from the row the user selected to include other rows having a key value of A (802 and 804). The key value can be read from the selected row(s) and added to the selected key value set. FIG. 9 is a diagram of the GUI 500 in which the selected rows (802 and 804) are no longer visible within the GUI view port 504. For example, the data object (e.g., a table) may be updating dynamically and new rows have been added and caused the selected rows to move outside of the viewport 504. The selected data persists as selected via the selected value set even though selected rows may no longer be visible within the viewport 504. In some implementations, the GUI may maintain selected data as visible within a viewport by recomputing location and recentering the viewport to show some or all of the selected data.

In some implementations, a selected row may be removed from a data object and the key value for the removed row may be maintained in the selected key value set until the selected key value set is cleared (e.g., by receiving a new selection, which clears the previous selection). In some implementations, when a selected row changes, the change may not alter the selection (e.g., the selected key value set).

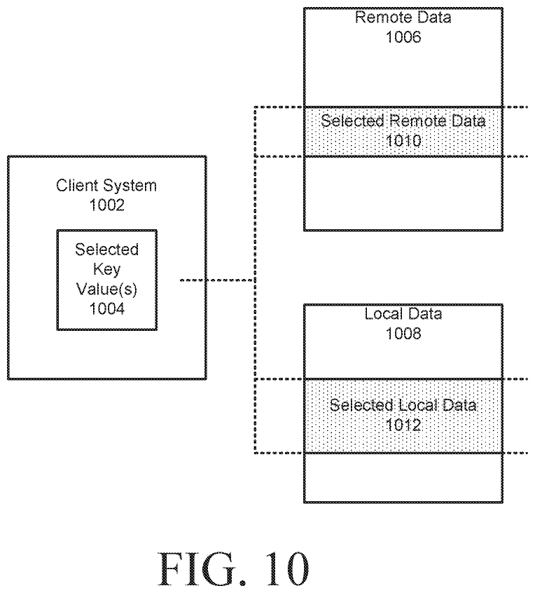

FIG. 10 is a diagram showing an example of selected key values 1004 corresponding to selected local data 1012 within a local data store 1008 and selected remote data 1010 within a remote data store 1006.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC), a field programmable gate array (FPGA), GPGPU, GPU, or the like. The instructions can be compiled from source code instructions provided in accordance with a programming language such as Java, C, C++, C #.net, assembly or the like. The instructions can also comprise code and data objects provided in accordance with, for example, the Visual Basic™ language, a specialized database query language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, or the like.

It is, therefore, apparent that there is provided, in accordance with the various embodiments disclosed herein, methods, systems and computer readable media for keyed row selection and data processing operations using selected data.

Application Ser. No. 15/154,974, entitled “DATA PARTITIONING AND ORDERING” (Attorney Docket No. W1.1-10057) and filed in the United States Patent and Trademark Office on May 14, 2016, is hereby incorporated by reference herein in its entirety as if fully set forth herein.

Application Ser. No. 15/154,975, entitled “COMPUTER DATA SYSTEM DATA SOURCE REFRESHING USING AN UPDATE PROPAGATION GRAPH” (Attorney Docket No. W1.4-10058) and filed in the United States Patent and Trademark Office on May 14, 2016, is hereby incorporated by reference herein in its entirety as if fully set forth herein.

Application Ser. No. 15/154,979, entitled “COMPUTER DATA SYSTEM POSITION-INDEX MAPPING” (Attorney Docket No. W1.5-10083) and filed in the United States Patent and Trademark Office on May 14, 2016, is hereby incorporated by reference herein in its entirety as if fully set forth herein.

Application Ser. No. 15/154,980, entitled “SYSTEM PERFORMANCE LOGGING OF COMPLEX REMOTE QUERY PROCESSOR QUERY OPERATIONS” (Attorney Docket No. W1.6-10074) and filed in the United States Patent and Trademark Office on May 14, 2016, is hereby incorporated by reference herein in its entirety as if fully set forth herein.

Application Ser. No. 15/154,983, entitled “DISTRIBUTED AND OPTIMIZED GARBAGE COLLECTION OF REMOTE AND EXPORTED TABLE HANDLE LINKS TO UPDATE PROPAGATION GRAPH NODES” (Attorney Docket No. W1.8-10085) and filed in the United States Patent and Trademark Office on May 14, 2016, is hereby incorporated by reference herein in its entirety as if fully set forth herein.

Application Ser. No. 15/154,984, entitled “COMPUTER DATA SYSTEM CURRENT ROW POSITION QUERY LANGUAGE CONSTRUCT AND ARRAY PROCESSING QUERY LANGUAGE CONSTRUCTS” (Attorney Docket No. W2.1-10060) and filed in the United States Patent and Trademark Office on May 14, 2016, is hereby incorporated by reference herein in its entirety as if fully set forth herein.

Application Ser. No. 15/154,985, entitled “PARSING AND COMPILING DATA SYSTEM QUERIES” (Attorney Docket No. W2.2-10062) and filed in the United States Patent and Trademark Office on May 14, 2016, is hereby incorporated by reference herein in its entirety as if fully set forth herein.

Application Ser. No. 15/154,987, entitled “DYNAMIC FILTER PROCESSING” (Attorney Docket No. W2.4-10075) and filed in the United States Patent and Trademark Office on May 14, 2016, is hereby incorporated by reference herein in its entirety as if fully set forth herein.

Application Ser. No. 15/154,988, entitled “DYNAMIC JOIN PROCESSING USING REAL-TIME MERGED NOTIFICATION LISTENER” (Attorney Docket No. W2.6-10076) and filed in the United States Patent and Trademark Office on May 14, 2016, is hereby incorporated by reference herein in its entirety as if fully set forth herein.

Application Ser. No. 15/154,990, entitled “DYNAMIC TABLE INDEX MAPPING” (Attorney Docket No. W2.7-10077) and filed in the United States Patent and Trademark Office on May 14, 2016, is hereby incorporated by reference herein in its entirety as if fully set forth herein.

Application Ser. No. 15/154,991, entitled “QUERY TASK PROCESSING BASED ON MEMORY ALLOCATION AND PERFORMANCE CRITERIA” (Attorney Docket No.

W2.8-10094) and filed in the United States Patent and Trademark Office on May 14, 2016, is hereby incorporated by reference herein in its entirety as if fully set forth herein.

Application Ser. No. 15/154,993, entitled “A MEMORY-EFFICIENT COMPUTER SYSTEM FOR DYNAMIC UPDATING OF JOIN PROCESSING” (Attorney Docket No.

W2.9-10107) and filed in the United States Patent and Trademark Office on May 14, 2016, is hereby incorporated by reference herein in its entirety as if fully set forth herein.

Application Ser. No. 15/154,995, entitled “QUERY DISPATCH AND EXECUTION ARCHITECTURE” (Attorney Docket No. W3.1-10061) and filed in the United States Patent and Trademark Office on May 14, 2016, is hereby incorporated by reference herein in its entirety as if fully set forth herein.

Application Ser. No. 15/154,996, entitled “COMPUTER DATA DISTRIBUTION ARCHITECTURE” (Attorney Docket No. W3.2-10087) and filed in the United States Patent and Trademark Office on May 14, 2016, is hereby incorporated by reference herein in its entirety as if fully set forth herein.

Application Ser. No. 15/154,997, entitled “DYNAMIC UPDATING OF QUERY RESULT DISPLAYS” (Attorney Docket No. W3.3-10059) and filed in the United States Patent and Trademark Office on May 14, 2016, is hereby incorporated by reference herein in its entirety as if fully set forth herein.

Application Ser. No. 15/154,998, entitled “DYNAMIC CODE LOADING” (Attorney Docket No. W3.4-10065) and filed in the United States Patent and Trademark Office on May 14, 2016, is hereby incorporated by reference herein in its entirety as if fully set forth herein.

Application Ser. No. 15/154,999, entitled “IMPORTATION, PRESENTATION, AND PERSISTENT STORAGE OF DATA” (Attorney Docket No. W3.5-10088) and filed in the United States Patent and Trademark Office on May 14, 2016, is hereby incorporated by reference herein in its entirety as if fully set forth herein.

Application Ser. No. 15/155,001, entitled “COMPUTER DATA DISTRIBUTION ARCHITECTURE” (Attorney Docket No. W3.7-10079) and filed in the United States Patent and Trademark Office on May 14, 2016, is hereby incorporated by reference herein in its entirety as if fully set forth herein.

Application Ser. No. 15/155,005, entitled “PERSISTENT QUERY DISPATCH AND EXECUTION ARCHITECTURE” (Attorney Docket No. W4.2-10089) and filed in the United States Patent and Trademark Office on May 14, 2016, is hereby incorporated by reference herein in its entirety as if fully set forth herein.

Application Ser. No. 15/155,006, entitled “SINGLE INPUT GRAPHICAL USER INTERFACE CONTROL ELEMENT AND METHOD” (Attorney Docket No. W4.3-10063) and filed in the United States Patent and Trademark Office on May 14, 2016, is hereby incorporated by reference herein in its entirety as if fully set forth herein.

Application Ser. No. 15/155,007, entitled “GRAPHICAL USER INTERFACE DISPLAY EFFECTS FOR A COMPUTER DISPLAY SCREEN” (Attorney Docket No. W4.4-10090) and filed in the United States Patent and Trademark Office on May 14, 2016, is hereby incorporated by reference herein in its entirety as if fully set forth herein.

Application Ser. No. 15/155,009, entitled “COMPUTER ASSISTED COMPLETION OF HYPERLINK COMMAND SEGMENTS” (Attorney Docket No. W4.5-10091) and filed in the United States Patent and Trademark Office on May 14, 2016, is hereby incorporated by reference herein in its entirety as if fully set forth herein.

Application Ser. No. 15/155,010, entitled “HISTORICAL DATA REPLAY UTILIZING A COMPUTER SYSTEM” (Attorney Docket No. W5.1-10080) and filed in the United States Patent and Trademark Office on May 14, 2016, is hereby incorporated by reference herein in its entirety as if fully set forth herein.

Application Ser. No. 15/155,011, entitled “DATA STORE ACCESS PERMISSION SYSTEM WITH INTERLEAVED APPLICATION OF DEFERRED ACCESS CONTROL FILTERS” (Attorney Docket No. W6.1-10081) and filed in the United States Patent and Trademark Office on May 14, 2016, is hereby incorporated by reference herein in its entirety as if fully set forth herein.

Application Ser. No. 15/155,012, entitled “REMOTE DATA OBJECT PUBLISHING/SUBSCRIBING SYSTEM HAVING A MULTICAST KEY-VALUE PROTOCOL” (Attorney Docket No. W7.2-10064) and filed in the United States Patent and Trademark Office on May 14, 2016, is hereby incorporated by reference herein in its entirety as if fully set forth herein.

Application Ser. No. 15/351,429, entitled “QUERY TASK PROCESSING BASED ON MEMORY ALLOCATION AND PERFORMANCE CRITERIA” (Attorney Docket No.

W2.11-10112) and filed in the United States Patent and Trademark Office on Nov. 14, 2016, is hereby incorporated by reference herein in its entirety as if fully set forth herein.

Application Ser. No. 15/813,112, entitled “COMPUTER DATA SYSTEM DATA SOURCE REFRESHING USING AN UPDATE PROPAGATION GRAPH HAVING A MERGED JOIN LISTENER” (Attorney Docket No. W2.10-10111) and filed in the United States Patent and Trademark Office on Nov. 14, 2017, is hereby incorporated by reference herein in its entirety as if fully set forth herein.

Application Ser. No. 15/813,142, entitled “COMPUTER DATA SYSTEM DATA SOURCE HAVING AN UPDATE PROPAGATION GRAPH WITH FEEDBACK CYCLICALITY” (Attorney Docket No. W2.12-10178) and filed in the United States Patent and Trademark Office on Nov. 14, 2017, is hereby incorporated by reference herein in its entirety as if fully set forth herein.

Application Ser. No. 15/813,127, entitled “COMPUTER DATA DISTRIBUTION ARCHITECTURE CONNECTING AN UPDATE PROPAGATION GRAPH THROUGH MULTIPLE REMOTE QUERY PROCESSORS” (Attorney Docket No. W3.9-10113) and filed in the United States Patent and Trademark Office on Nov. 14, 2017, is hereby incorporated by reference herein in its entirety as if fully set forth herein.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A computer-implemented method for processing keyed row selection of a computer data system data object, the method comprising:
receiving, at a processor, a selection of one or more keyed rows of the computer data system data object, the selection being received from a graphical user interface that is displaying at least a portion of data from the computer data system object;
adding, using the processor, one or more key values corresponding to the selection to a selected key values set stored in a computer readable medium coupled to the processor;
receiving, at the processor, an indication of an operation that utilizes data corresponding to the one or more key values;
determining, at the processor, whether the data corresponding to the one or more key values is stored within a local data store;
when the data corresponding to the one or more key values is stored within the local data store:
retrieving, using the processor, the data corresponding to the one or more key values from the local data store;
providing, using the processor, data retrieved from the local data store to an application;
determining, at the processor, whether a portion of the data corresponding to the one or more key values is not stored in the local data store and is stored in a remote data store;
when a portion of the data corresponding to the one or more key values is not stored in the local data store and is stored in the remote data store:
requesting, using the processor, data from the remote data store;
receiving, at the processor, at least a portion of requested data from the remote data store; and
providing, using the processor, data received from the remote data store to the application.

2. The computer-implemented method of claim 1, further comprising updating the graphical user interface based on the selection.

3. The computer-implemented method of claim 1, further comprising maintaining the selected key values set when the selection is no longer visible within the graphical user interface.

4. The computer-implemented method of claim 1, wherein providing data received from the local data store to the application and providing data received from the remote data store to the application include storing received data in a temporary working data store.

5. The computer-implemented method of claim 1, further comprising:
receiving an update to the computer data system data object, wherein the update includes a change to the selection; and
performing an update on the selection based on the update to the computer data system data object.

6. The computer-implemented method of claim 1, wherein the data returned from the remote data store includes indexes for accessing data stored on remote data store.

7. The computer-implemented method of claim 1, further comprising:
receiving, at the processor, an indication that a new row has been added to the computer data system data object;
determining, using the processor, whether the new row is within the selection based on the selected key values set; and
if the new row is part of the selection:
updating, using the processor, the graphical user interface to indicate the new row is within the selection; and
providing, from the processor, the new row to the application.

8. The computer-implemented method of claim 1, further comprising resetting the selected key values set when a new selection is received.

9. A system for dynamically updating a remote computer data system data object, the system comprising:
a processor coupled to a nontransitory computer readable medium having stored thereon software instructions that, when executed by the processor, cause the processor to perform operations including:
receiving, at a processor, a selection of one or more keyed rows of the computer data system data object, the selection being received from a graphical user interface that is displaying at least a portion of data from the computer data system object;
adding, using the processor, one or more key values corresponding to the selection to a selected key values set stored in a computer readable medium coupled to the processor;
receiving, at the processor, an indication of an operation that utilizes data corresponding to the one or more key values;
determining, at the processor, whether the data corresponding to the one or more key values is stored within a local data store;
when the data corresponding to the one or more key values is stored within the local data store:
retrieving, using the processor, the data corresponding to the one or more key values from the local data store;
providing, using the processor, data retrieved from the local data store to an application;
determining, at the processor, whether a portion of the data corresponding to the one or more key values is not stored in the local data store and is stored in a remote data store;
when a portion of the data corresponding to the one or more key values is not stored in the local data store and is stored in the remote data store:
requesting, using the processor, data from the remote data store;
receiving, at the processor, at least a portion of requested data from the remote data store; and
providing, using the processor, data received from the remote data store to the application.

10. The system of claim 9, wherein the operations further include updating the graphical user interface based on the selection.

11. The system of claim 9, wherein the operations further include maintaining the selected key values set when the selection is no longer visible within the graphical user interface.

12. The system of claim 9, wherein providing data received from the local data store to the application and providing data received from the remote data store to the application include storing received data in a temporary working data store.

13. The system of claim 9, wherein the operations further include:
receiving an update to the computer data system data object, wherein the update includes a change to the selection; and
performing an update on the selection based on the update to the computer data system data object.

14. The system of claim 9, wherein the data returned from the remote data store includes indexes for accessing data stored on remote data store.

15. The system of claim 9, further comprising:
receiving, at the processor, an indication that a new row has been added to the computer data system data object;
determining, using the processor, whether the new row is within the selection based on the selected key values set; and
if the new row is part of the selection:
updating, using the processor, the graphical user interface to indicate the new row is within the selection; and
providing, from the processor, the new row to the application.

16. The system of claim 9, further comprising resetting the selected key values set when a new selection is received.

17. A nontransitory computer readable medium having stored thereon software instructions that, when executed by a processor, cause the processor to perform operations including:
receiving, at a processor, a selection of one or more keyed rows of the computer data system data object, the selection being received from a graphical user interface that is displaying at least a portion of data from the computer data system object;
adding, using the processor, one or more key values corresponding to the selection to a selected key values set stored in a computer readable medium coupled to the processor;
receiving, at the processor, an indication of an operation that utilizes data corresponding to the one or more key values;
determining, at the processor, whether the data corresponding to the one or more key values is stored within a local data store;
when the data corresponding to the one or more key values is stored within the local data store:
retrieving, using the processor, the data corresponding to the one or more key values from the local data store;
providing, using the processor, data retrieved from the local data store to an application;
determining, at the processor, whether a portion of the data corresponding to the one or more key values is not stored in the local data store and is stored in a remote data store;
when a portion of the data corresponding to the one or more key values is not stored in the local data store and is stored in the remote data store:
requesting, using the processor, data from the remote data store;
receiving, at the processor, at least a portion of requested data from the remote data store; and
providing, using the processor, data received from the remote data store to the application.

18. The nontransitory computer readable medium of claim 17, wherein the operations further include updating the graphical user interface based on the selection.

19. The nontransitory computer readable medium of claim 17, wherein the operations further include maintaining the selected key values set when the selection is no longer visible within the graphical user interface.

20. The nontransitory computer readable medium of claim 17, wherein providing data received from the local data store to the application and providing data received from the remote data store to the application include storing received data in a temporary working data store.
